(19) United States
(12) Patent Application Publication
(10) Pub. No.: US 2015/0044360 A1
(43) Pub. Date: Feb. 12, 2015

(54) METHOD FOR PRODUCING A METALLISED SUBSTRATE CONSISTING OF ALUMINIUM

(71) Applicant: A.B. Mikroelektronik Gesellschaft mit beschraenkter Haftung, Salzburg (AT)

(72) Inventors: Robert Christopher BURNS, Salzburg (AT); Wolfgang TUSLER, Salzburg (AT); Bernd HAEGELE, Engelsberg (DE)

(21) Appl. No.: 14/525,651

(22) Filed: Oct. 28, 2014

Related U.S. Application Data
(63) Continuation of application No. PCT/AT2013/000059, filed on Apr. 8, 2013.

(30) Foreign Application Priority Data
May 4, 2012 (AT) A 527/2012

(51) Int. Cl. B05D 3/02; H01B 13/00; B05D 3/12; C23C 26/00; B05D 1/32

(52) U.S. Cl. CPC B05D 3/0209; C23C 26/00; B05D 1/322; B05D 3/12; H01B 13/0036; H01B 13/0016
USPC 427/123

(57) ABSTRACT

The invention relates to a method for producing a metalized substrate which consists at least partially, and preferably entirely, of aluminium and/or an aluminium alloy. A conductive paste is applied to at least some sections of a surface of said substrate; in a first firing phase, the conductive paste is exposed to a substantially continuously increasing firing temperature which is increased to a predefinable maximum firing temperature of less than approximately 660° C.; in a second firing phase, the conductive paste is substantially exposed to said predefinable maximum firing temperature for a predefinable time period; in a cooling phase, the conductive paste is cooled down; and in a post-treatment phase, a surface of the conductive paste is mechanically post-treated, preferably brushed.

The invention concerns a method of producing a metalized substrate, wherein the substrate at least partially and preferably entirely comprises aluminum and/or an aluminum alloy.

The material aluminum is of ever increasing significance in particular in the field of power electronics. Due to its comparatively low weight and low costs aluminum is frequently used as a cooling body for electronic components like for example power electronic modules (for example LEDs, IGBTs or MOSFETs) or also directly as a current-carrying conductor, in particular as a current or bus bar. For those purposes of use aluminum has both a very high level of thermal conductivity of about 235W/(m*K) and also a very high level of electrical conductivity of about 37*10⁶ A/(V*m). A chemical property of aluminum is a thin oxide layer which forms very quickly in contact with air and which is formed by contact with oxygen in the atmosphere as a consequence of an oxidation process at the surface of an aluminum body. Admittedly that oxide layer affords on the one hand corrosion protection but on the other hand it causes difficulty in connecting aluminum to other materials by soldering, welding or other known connecting procedures.

Therefore the object of the invention is to provide an improved method of producing a metalized substrate which predominantly comprises aluminum and/or an aluminum alloy. In particular the invention seeks to provide that the surface of the substrate is made solderable to be able to produce electrical contacting with the substrate.

According to the invention that object is attained by the features of claim 1. Advantageous configurations of the invention are recited in the appendant claims.

According to the invention therefore it is provided that a conductor paste is applied at least region-wise to a surface of the substrate, in a first firing phase the conductor paste is exposed to a substantially continuously increasing firing temperature, wherein the firing temperature is increased to a predeterminable maximum firing temperature of less than about 660° C., in a second firing phase the conductor paste is exposed substantially to the predeterminable maximum firing temperature for a predeterminable period of time, in a cooling phase the conductor paste is cooled down and in a post-treatment phase a surface of the conductor paste is mechanically post-treated, preferably brushed.

The surface of a substrate, in particular an aluminum substrate, can be reliably metalized by the specified method steps. The regions at which the conductor paste is applied by the specified method and sintered in accordance with the method steps provide for electrical contacting of the substrate instead of the oxidized surface of the substrate, that prevails in that region. That electrically conductive layer which is achieved at least region-wise by the application and sintering of the conductor paste can consequently be used for example for soldering an electronic component thereto or also for soldering on a cooling body, wherein the cooling body itself can again comprise aluminum.

In that case the substrate can at least partially and preferably completely comprise an aluminum material with as high a proportion of aluminum as possible. Preferably an aluminum material is used of the quality EN AW-1050A or EN AW-1060A in accordance with European Standard EN 573, which contains at least 99.5% by weight or 99.6% by weight of aluminum. In spite of somewhat lower liquidus temperatures and lower thermal conductivity in comparison with the above-mentioned substantially pure aluminum materials it is also possible to use aluminum alloys, for example aluminum alloys containing manganese or magnesium like for example EN AW-3003 (AlMn1Cu), EN AW-3103 (AlMn1), EN AW-5005 (AlMg1) or EN AW-5754 (AlMg3).

The proposed method affords the possibility of selectively metalizing individual regions of the surface of an aluminum-based substrate, wherein the metalized regions are joined in the form of a sintered conductor paste to the substrate directly in bonding joining of the materials involved and wherein, in that way, it is possible to achieve high electrical conductivity and high thermal conductivity of conductor paste to substrate and vice-versa. The metalized regions additionally represent solderable regions, by which the substrate can be joined to further components in known fashion. Thus for example individual electronic components can be soldered on to the metalized regions using conventional soldering agents like eutectic Sn—Pb—, Sn—Ag—Cu— or Sn—Au-solders.

For improved heat dissipation, potential-free connections of components like high-power LED modules or power electronic modules can also be soldered on to an aluminum substrate by the metalized regions without having to use an interposed insulating dielectric layer and without an expensive silver-based heat conducting paste, whereby overall a lower degree of thermal resistance can be achieved. Due to the reduced thermal resistance and the increased thermal conductivity the structural sizes of the components joined to the substrate can be reduced or they can be operated with higher power deliveries. Conventional soldering agents (see above) can be used for soldering the components to the metalized regions. It is thus possible to dispense with special aluminum soldering agents which often contain halogens and other substance which are harmful to health.

A further area of use of the proposed method is the metallization of aluminum current bus bars for improving the reliability of the connections to current cables connected thereto. Metallization of the surface of an aluminum bus bar with a copper-based conductor paste makes it possible in particular to prevent intermetallic diffusion phenomena and electrochemical reactions with copper current cables connected thereto.

According to a particularly preferred embodiment it can be provided that the conductor paste is applied to the surface of the substrate by a screen printing process.

The screen printing technology is an established process for producing conductor tracks on substrates. In the field of power electronics a so-called “insulated metal substrate” (IMS) is frequently used as the substrate, which includes a core of aluminum and which is encased by an electrically insulating or dielectric layer. The core of aluminum is used in this case for improved thermal conduction. The conductor tracks themselves which are applied to the insulating layer for example by means of screen printing are in that case not electrically contacted with the core of aluminum.

An aim of the invention however is to achieve direct electrical contacting of conductor tracks disposed on the substrate, with the substrate itself. That is made possible insofar as the conductor tracks or conductor surfaces can be arranged directly on the substrate by means of the proposed method without having to provide an insulating layer therebetween. A connection involving bonding joining of the materials involved is achieved between sintered conductor paste and substrate, by which the sintered conductor paste is electrically and thermally contacted directly with the substrate. In that respect conventional conductor pastes in the form of thick-layer pastes or sinter pastes can be used. Due to the porosity of thick-layer pastes it is possible to compensate for different degrees of thermal expansion of conductor paste and substrate whereby the reliability of the join between the conductor paste and the substrate can be increased, in particular in the case of major cyclic thermal stresses like for example in the automobile field.

The additive nature of the screen printing process, with which layers are built up on a substrate, means that it is also possible to dispense with the use of exposure and etching processes for metallization of a substrate surface, and that leads to cost advantages for the proposed method.

A thick-layer conductor paste usually includes at least a metal powder as an electrically conductive agent, an inorganic powder (for example glass frits) as a bonding agent, and organic binding and dissolving agents. The organic binding and dissolving agents lead to a paste-like consistency enjoying given rheological properties which however are also influenced by the further constituents of the conductor paste.

In regard to the constituent of the electrically conductive metal powder it can preferably be provided that a conductor paste including a copper powder is used. It will be appreciated however that it is also possible to use a conductor paste including a silver and/or gold powder. The use of copper powder however is markedly less expensive in that respect.

In regard to the constituent of the inorganic powder it can preferably be provided that a conductor paste is used, containing a glass from the PbO—B₂O₃—SiO₂ system and/or a glass including Bi₂O₃. In that way, during the sintering process in the proposed method, in spite of the comparatively low firing temperatures prevailing in that situation, it is possible to achieve very good adhesion of the conductor paste to the substrate.

After a conductor paste is applied by printing, for example by a screen printing process known in the state of the art, the conductor paste remains substantially on the corresponding regions by virtue of its rheological properties, without flow to any extent worth mentioning. In order to prepare the conductor paste applied to the surface of the substrate in optimum fashion for the firing or sintering operation, it can preferably be provided that prior to the first firing phase the conductor paste is dried in a drying phase at a temperature of between about 80° C. and about 200° C., preferably between 100° C. and 150° C., particularly preferably at a maximum 130° C., preferably for a period of time of between about 5 min and about 20 min. Due to that drying phase the solvents present in the conductor phase are substantially completely dissipated. In that respect known drying methods like for example infrared or hot air drying are preferred. Due to the drying process and the linked dissipation of the solvents in the conductor paste the conductor paste experiences a certain shrinkage in volume. It is however already possible to counteract that beforehand by applying the conductor paste in a correspondingly thicker layer.

Firing or sintering of the conductor paste in the first and/or second firing phase of the proposed method can preferably be effected in a firing furnace, the firing temperature prevailing therein. It will be appreciated that the drying phase and/or the cooling phase can also be effected in the firing furnace. Preferably in that case a firing furnace with a conveyor device can be used.

A suitable firing profile can be applied in dependence on the material combination used, of substrate and conductor paste. A particular variant provides that in the first firing phase the firing temperature is increased at least temporarily by between about 40° C./min and about 60° C./min. It can further be provided that in the first firing phase the firing temperature is increased to a maximum firing temperature of about 580° C., preferably about 565° C., particularly preferably about 548° C. Heating the conductor paste over between about 400° C. and 450° C. has the result that all organic constituents therein like for example organic binding agents are substantially completely dissolved and the inorganic constituents (for example glass powder or glass frits) soften. In addition the metal powder sintering process starts at those temperatures. The softened glass constituents of the conductor paste further result in good adhesion bonding of the conductor paste on the substrate.

The maximum firing temperature is basically limited by the melting temperature of aluminum, which is about 660° C. When using a silver-based conductor paste the maximum firing temperature is preferably about 565° C. while when using a copper-based conductor paste the maximum firing temperature is preferably about 548° C. Those temperatures derive from the melting temperatures of possible eutectic aluminum-copper or aluminum-silver alloys which occur in that case.

In regard to the respective maximum firing temperature suitable glass constituents are to be selected for a conductor paste, the corresponding glass transition temperature (T_{G}) or melting temperature (Tₛ) of those constituents being adapted to that maximum firing temperature. The glass transition temperature or melting temperature of the glass constituent of the corresponding conductor paste should accordingly be suitably below the specified maximum firing temperatures to ensure optimum adhesion of the conductor paste to the substrate. In particular glasses from the PbO—B₂O₃—SiO₂ system or glasses including Bi₂O₃ are suitable.

It has proven to be particularly advantageous if firing of the conductor paste in the second firing phase is effected for between about 5 min and about 30 min. Basically, the longer the period of time in the second firing phase (at the maximum firing temperature), the correspondingly more densely is the conductor paste sintered and thus has better properties for further processing (for example soldering and welding). If excessively long periods of time are used in the second firing phase however the transit time in a typical firing furnace is correspondingly increased in length, which can have an adverse effect on the overall through-put.

In a further advantageous variant it can be provided that the predeterminable maximum firing temperature is kept substantially constant in the second firing phase.

In addition it can preferably be provided that the conductor paste in the first firing phase and/or the second firing phase is exposed to a protective gas atmosphere including nitrogen. A protective gas atmosphere (for example nitrogen) is advantageous for burning in copper conductor track pastes in order to prevent oxidation of the conductor track material (depending on the firing phase there can be a residual oxygen content of some ppm). The organic binders of such a material or the conductor paste can in that case be so conceived that they can be reduced under a nitrogen atmosphere. In turn a conventional air atmosphere can be advantageous for silver conductor track pastes because that does not involve any serious impairment of the conductor track surface due to oxidation. The organic binders used in that case can be oxidized by way of the oxygen in the air.

In a preferred embodiment of the invention it can be provided that in the cooling phase the firing temperature is reduced at least temporarily by between about 20° C./min and about 40° C./min, preferably by about 30° C./min. Preferably in that case cooling is effected to ambient temperature. The slower the cooling operation, the correspondingly less are the mechanical effects on the connection between the conductor paste and the substrate by virtue of different coefficients of thermal expansion of the materials used.

Due to the typical oxidation of the sintered conductor paste, which occurs during the firing or sintering process due to the high temperatures prevailing then, it is provided that the surface of the conductor paste is suitably mechanically post-treated after the cooling step in order to facilitate further processing, for example for subsequent soldering or welding processes.

According to a preferred embodiment it can be provided that the conductor paste is applied in a thickness of between about 10 μm and about 100 μm to the surface of the substrate. It will be appreciated that it is also possible to apply conductor pastes in a thickness of less than 10 μm or conductor pastes in a thickness of more than 100 μm to the surface of the substrate. It can also be provided that the proposed method is applied a plurality of times in succession in order to increase the overall resulting conductor paste thickness.

Further details and advantages of the present invention are described by means of the specific description hereinafter. In the drawing:

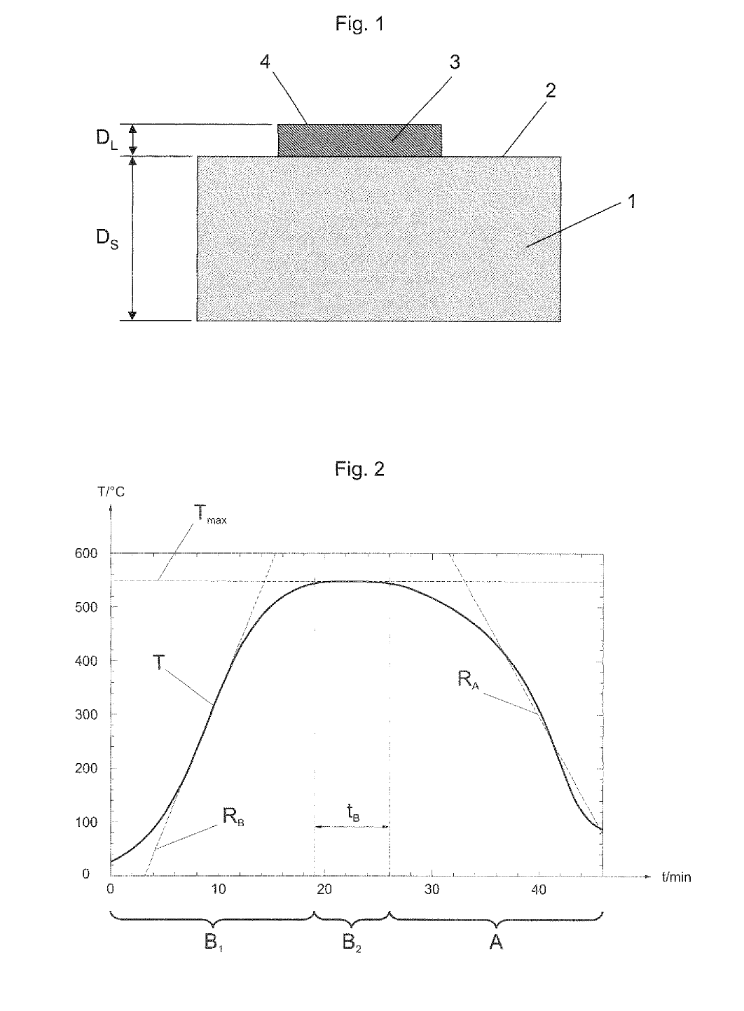

FIG. 1 shows a section through a substrate with conductor paste arranged thereon, and

FIG. 2 shows a firing profile of the firing temperature in relation to time for an embodiment of the proposed method.

FIG. 1 shows a cross-section (not to scale) through a substrate 1 of substantially pure aluminum or a high-purity aluminum alloy after carrying out a proposed method. In this case the substrate 1 comprises for example an aluminum material of the quality EN AW-1050A in accordance with European Standard EN 573, which contains at least 99.5% by weight of aluminum. The substrate 1 is of a thickness D_{S} of about 2 mm and has a substantially flat surface 2. In general the substrate 1 can be of a thickness D_{S} of at least 1 mm while a maximum reasonable thickness D_{S} can be limited by further processing of the substrate 1.

A copper-based conductor paste 3 was applied to the surface 2 of the substrate 1 by means of a screen printing process, that is to say the conductor paste 3 used contains a copper powder as the electrically conductive constituent. The substrate 1 together with the conductor paste 3 was treated in accordance with a proposed method using the firing profile of FIG. 2 to obtain a solderable aluminum substrate 1. The thickness D_{L} of the fired or sintered conductor paste 3 after using the proposed method is about 35 μm in this example. The thickness D_{L} of the fired or sintered conductor paste can be for example between about 20 μm and about 40 μm for copper conductor track pastes and between about 10 μm and about 20 μm for silver conductor track pastes. To improve the soldering properties of the conductor paste 3 which was fired or sintered in the proposed method the surface 4 of the sintered conductor paste 3 was mechanically post-treated, for example brushed.

FIG. 2 shows a possible firing profile for the proposed method. In this respect the illustrated diagram represents the variation in respect of time of the firing temperature T in a firing furnace, in which the first firing phase B₁, the second firing phase B₂ and the cooling phase A were carried out. In the first firing phase B₁, starting from an ambient temperature of about 22° C., the firing temperature T was continuously increased to a predeterminable maximum firing temperature Tₘₐₓ of about 542° C. The variation in respect of time of the firing temperature T in the first firing phase B₁ is in this case substantially S-shaped with a substantially linear portion in which the firing temperature T was increased at a rate R_{B} of about 46° C./min.

After reaching the predeterminable maximum firing temperature Tₘₐₓ the conductor paste 3 and the substrate 1 were exposed in the second firing phase B₂ to the predeterminable maximum firing temperature Tₘₐₓ of about 542° C. for a predeterminable period t_{B} of about 9 min, and thus the conductor paste 3 was fired or sintered.

In the following cooling phase A the firing temperature T was continuously reduced, wherein the firing temperature T decreases in relation to time t in a substantially S-shaped configuration. The reduction rate R_{A} of the firing temperature T in the cooling phase A was approximately on average about 33° C./min.

1. A method of producing a metalized substrate, wherein the substrate at least partially and preferably entirely comprises aluminum and/or an aluminum alloy, wherein a conductor paste is applied at least region-wise to a surface of the substrate, in a first firing phase the conductor paste is exposed to a substantially continuously increasing firing temperature, wherein the firing temperature is increased to a predeterminable maximum firing temperature of less than about 660° C., in a second firing phase the conductor paste is exposed substantially to the predeterminable maximum firing temperature for a predeterminable period of time, in a cooling phase the conductor paste is cooled down and in a post-treatment phase a surface of the conductor paste is mechanically post-treated, preferably brushed.

2. A method as set forth in claim 1, wherein the conductor paste is applied to the surface of the substrate by a screen printing process.

3. A method as set forth in claim 1, wherein a conductor paste including a copper powder is used.

4. A method as set forth in claim 1, wherein a conductor paste including a glass from the PbO—B₂O₃—SiO₂ system and/or a glass including Bi₂O₃ is used.

5. A method as set forth in claim 1, wherein prior to the first firing phase the conductor paste is dried in a drying phase at a temperature of between about 80° C. and about 200° C., preferably between 100° C. and 150° C., particularly preferably at a maximum 130° C., preferably for a period of time of between about 5 min and about 20 min.

6. A method as set forth in claim 1, wherein at least firing of the conductor paste in the first firing phase and/or the second firing phase is effected in a firing furnace, the firing temperature prevailing in the firing furnace.

7. A method as set forth in claim 1, wherein in the first firing phase the firing temperature is increased at least temporarily by between about 40° C./min and about 60° C./min.

8. A method as set forth in claim 1, wherein in the first firing phase the firing temperature is increased to a maximum firing temperature of about 580° C., preferably about 565° C., particularly preferably about 548° C.

9. A method as set forth in claim 1, wherein firing of the conductor paste is effected in the second firing phase for between about 5 min and about 30 min.

10. A method as set forth in claim 1, wherein in the second firing phase the predeterminable maximum firing temperature is kept substantially constant.

11. A method as set forth in claim 1, wherein in the first firing phase and/or the second firing phase the conductor paste is exposed to a protective gas atmosphere including nitrogen.

12. A method as set forth in claim 1, wherein in the cooling phase the firing temperature is reduced at least temporarily by between about 20° C./min and about 40° C./min, preferably by about 30° C./min.

13. A method as set forth in claim 1, wherein the conductor paste is applied in a thickness of between about 10 μm and about 100 μm to the surface of the substrate.
